(19) United States
(12) Patent Application Publication
(10) Pub. No.: US 2002/0118597 A1
(43) Pub. Date: Aug. 29, 2002

(54) Mixing head with axial flow

(75) Inventor: Harald O. Korstvedt, Harvard, MA (US)

Correspondence Address: MILLS & ONELLO LLP, Suite 605, Eleven Beacon Street, Boston, MA, 02108, US

(73) Assignee: Silverson Machines Inc.

(21) Appl. No.: 10/056,668

(22) Filed: Oct. 29, 2001

Related U.S. Application Data
(63) Continuation-in-part of application No. 09/699,914, filed on Oct. 30, 2000.

(51) Int. Cl. B01F 5/12

(52) U.S. Cl. 366/265; 416/181

(57) ABSTRACT

A mixing head is provided for inducing axial flow of material in an inward direction toward a mixing chamber. The mixing head is machinable, and therefore relatively inexpensive to manufacture. In addition, the mixing head is modular, and therefore adaptable to a number of applications. Additionally, the mixing head can be disassembled, and is therefore relatively easy to clean and maintain.

### RELATED APPLICATIONS

This application is a continuation-in-part application of U.S. patent application Ser. No. 09,699,914, filed Oct. 30, 2000, the contents of which are incorporated herein by reference, in their entirety.

### BACKGROUND OF THE INVENTION

Contemporary closed-rotor rotary mixing heads are ideal for batch processing of materials, including foods, pharmaceuticals, and chemicals. The mixing head is mounted to a motor shaft for inducing rotary motion in the head. The head is submerged into a material to be mixed, and through rotary motion, initiates flow and mixing of the material. Opposed internal blades force fluid through slots formed in a cylindrical cage. The size and shape of the slots determines the flow, velocity and shear rates produced by the head.

An example mixing head is disclosed in U.S. Pat. No. 5,407,271, to Jorgensen et al. In this embodiment, upper and lower inwardly facing impeller blade units are fixedly mounted to opposite sides of a tubular mixing chamber including a plurality of shearing apertures. The blade units, when rotated, operate as axial pumps for delivering material to the inner region of the tubular mixing chamber. A positive pressure is created within the chamber that drives the pumped material in an outward direction. The material is sheared by the rotating shearing apertures as it is delivered out of the mixing chamber by the positive pressure. Because this embodiment is machined and welded together, it is expensive to manufacture, particularly with regard to grinding and polishing. It is also difficult to clean, because it is not configured for disassembly. Since it is a unitary piece, different heads must be purchased for different applications.

Another example is a mixer head manufactured by Scott Turbon Mixer, Inc., Adelando, Calif., U.S.A. With reference to U.S. Pat. Nos. 3,170,638 and 3,170,639, upon which The Scott Turbon Mixer technology is based, in these embodiments, upper and lower frusto-conical members deliver material using centrifugal flow to a cylindrical mixing chamber. The sides of the cone are continuous faces, the purpose of which is to deliver material entering the top of the cone in an outwardly centrifugal direction to the base of the cone, where the material enters the mixing chamber. This embodiment requires casting to form the components, since the cone configurations make it impractical to machine. Additionally, it is difficult to polish mechanically since the polishing machine must extend into the inner surfaces of the end cones for polishing.

### SUMMARY OF THE INVENTION

The present invention is directed to a mixing head that overcomes the limitations of conventional embodiments. Particularly, the present invention provides a mixing head that is entirely machinable, and therefore relatively inexpensive to manufacture. In addition, the mixing head is modular, and therefore adaptable to a number of applications. Additionally, the mixing head can be disassembled, and is therefore relatively easy to clean and maintain.

In one aspect the present invention is directed to a rotary mixing head for mixing material comprising first and second spaced-apart feeding elements having opposed inner faces. A cylindrical mixing screen is disposed about a longitudinal axis of the mixing head between the inner faces of the mixing elements. The region between the first and second feeding elements and within the mixing screen defines a mixing chamber. The first and second feeding elements including a plurality of openings formed at acute angles relative to the longitudinal axis such that when rotated, the first and second feeding elements induce material flow in an axial direction through the openings and into the mixing chamber.

In one embodiment, the openings have a substantially circular cross section. The openings may have respective center axes that lie on a circle centered at the longitudinal axis.

The feeding elements may be of a variety of shapes, including substantially flat and substantially conical. In the conical case, the openings may be formed in the conical surface along sections of the cone. The leading edge of the conical section opening may be beveled inwardly toward an interior of the cone so as to induce axial flow of material.

The cylindrical mixing screen may have openings of different shapes and sizes..

A sleeve may be provided between the first and second feeding elements, the sleeve being slightly shorter in length than the space between the feeding elements. First and second resilient O-rings may be provided at the interface of the sleeve and the first and second feeding elements. A bolt having a head and a thread may be used for mounting the mixing head to a rotary shaft. In this case, the first and second feeding elements include central bolt openings and the thread portion of the bolt passes through the central bolt openings and through the sleeve. The head is preferably larger in diameter than the bolt openings. Third and fourth resilient O-rings may be provided at the interface of the bolt and the first feeding element, and the second feeding element and the shaft.

The sleeve may include at least one lateral wing extending from a central body of the sleeve. The at least one lateral wing may be linear in profile, or, alternatively, curved.

The cylindrical mixing screen may include a plurality of mixing apertures spaced at intervals along a body portion and top and bottom edges. The top and bottom edges may include notches spaced at intervals for promoting material flow in the regions of the top and bottom edges.

In another aspect, the present invention is directed to a modular mixing head system. The system includes a plurality of first and second feeding elements adapted to have opposed inner faces. A plurality of cylindrical mixing screens are adapted to be disposed about a longitudinal axis of the mixing head between the inner faces of the mixing elements; the region between the first and second feeding elements and within the mixing screen defining a mixing chamber. The first and second feeding elements each include a plurality of openings such that when rotated, the first and second feeding elements induce material flow in an axial direction through the openings and into the mixing chamber. Any combination of the first and second feeding elements can be combined with one of the mixing screens to provide a desired mixing head configuration.

The feeding element openings can be formed at acute angles relative to the longitudinal axis. The angles may be different for each respective of the feeding elements. The respective feeding elements may have different numbers of openings, openings of different shapes and sizes. Similarly, the mixing screens may have mixing apertures of different shapes and sizes, and may be of different longitudinal lengths. In this manner, a modular mixing system is provided.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a partial-sectional side view, plus top and bottom views, of a rotary mixer head in accordance with the present invention. FIG. 1B is an exploded perspective view of the mixer head of FIG. 1A.

FIGS. 2A, 2B, and 2C are top views of various feeding elements of the FIG. 1 embodiment, including different numbers of openings, in accordance with the present invention.

FIGS. 3A, 3B, and 3C are side views of various mixing screens of the FIG. 1 embodiment, including different numbers, shapes, and sizes of openings, in accordance with the present invention.

FIG. 4A is a partial-sectional side view of a rotary mixer head in accordance with a first alternative embodiment of the present invention. FIG. 4B is an exploded perspective view of the mixer head of FIG. 4A.

FIG. 5A is a partial-sectional side view of a rotary mixer head in accordance with a second alternative embodiment of the present invention. FIG. 5B is an exploded perspective view of the mixer head of FIG. 5A.

FIGS. 6A, 6B, and 6C are top views of various feeding elements of the FIG. 5 embodiment, including different numbers of openings, in accordance with the present invention.

### DETAILED DESCRIPTION OF PREFERRED EMBODIMENTS

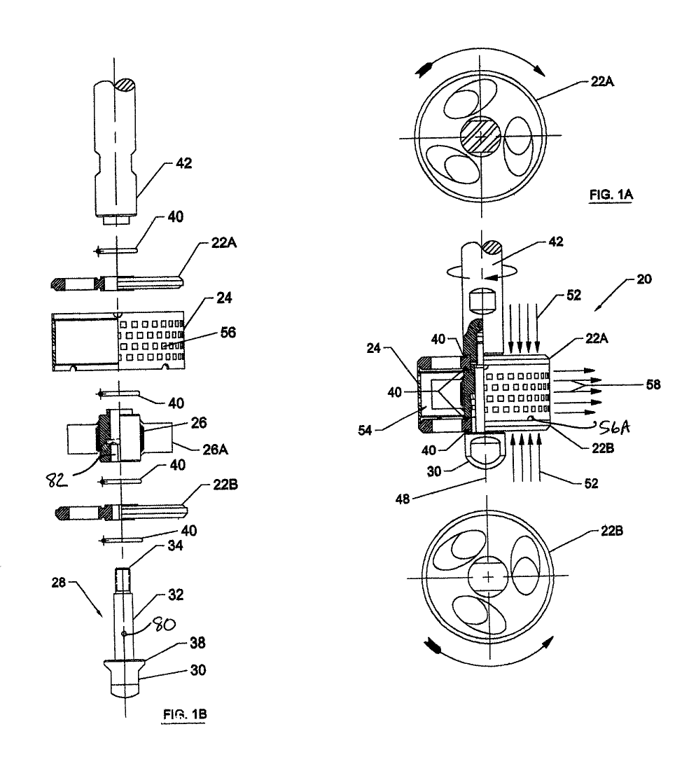

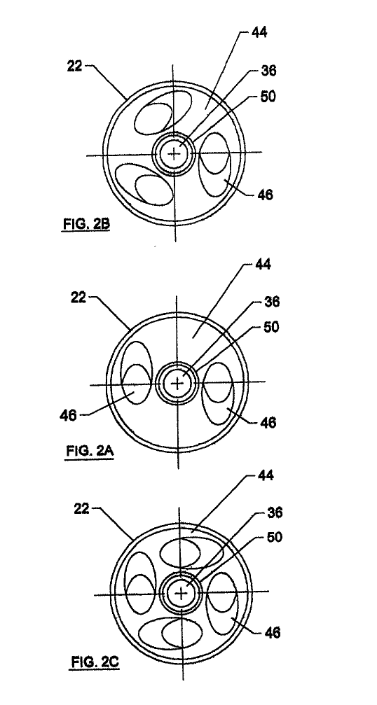

FIG. 1A is a partial-sectional side view, and FIG. 1B is an exploded perspective view, of a rotary mixer head 20 in accordance with the present invention. The mixer head 20 includes first and second feeding elements 22A, 22B mounted to opposite ends of a cylindrical mixing chamber screen 24. A cylindrical central sleeve 26 couples between interior portions of the feeding elements 22A, 22B. A bolt 28 includes a lower head 30 at a proximal end, a shoulder portion 32, and a thread 34 at a distal end. The bolt 28 is adapted to extend through a central bolt hole 36 (see FIG. 2) in the second feeding element 22B, through the cylindrical central sleeve 26, and through a bolt hole 36 in the first feeding element 22A. The head 30 includes a wide neck 38 that prevents the bolt 28 from passing completely through the bolt hole 36. The threads 34 on the bolt mount the mixer head to a corresponding mating female thread formed in a mixer shaft 42, which is coupled at the distal end to a rotary driver such as an electric motor. Resilient O-rings 40 are provided between the bolt head 30 and the second feeding element 22B, between the second feeding element 22B and the central sleeve 26, between the central sleeve 26 and the first feeding element 22A, and between the first feeding element 22A and the mixer shaft 42. The 0rings provide for a snug fit between the components that remains tight during operation, and further serve to prevent material from entering seams and crevices in the components. The central sleeve 26 can optionally be formed slightly shorter in length than the space between the feeding elements 22, relying on the compression of the O-rings to ensure a tight seal. The mixing chamber screen 24 is thus clamped tightly between the first and second feeding elements 22A, 22B.

FIGS. 2A, 2B, and 2C are top views of various feeding elements 22, in accordance with the present invention. The feeding elements 22 comprise an annular body 44 having a plurality of openings 46 formed at acute angles (for example 30-45 degrees) relative to the longitudinal axis 48 (see FIG. 1A) of the mixer head 20. The openings are preferably circular in cross-section for ease of manufacture; other shapes are equally applicable. The feeding elements further include a circular recess 50 adapted for receiving an O-ring 40. The first and second feeding elements 22A, 22B are formed and mounted as mirror images of each other, such that they both operate to pump material inwardly while rotating the same direction, as will be described below. Different flow solutions can be obtained, depending on the number and size of the openings 46, for example the FIG. 2A embodiment includes two openings 46 spaced 180 degrees apart, while the FIG. 2B and 2C embodiments include three and four equally-spaced openings respectively.

With reference to FIG. 1A, during operation of the mixing head 20, the head is submerged in a material to be mixed. Rotation of the head causes the openings 46 in the feeding element bodies 44 to draw material in an axial direction represented by arrows toward the center 54 of the mixing chamber 24. This causes a positive pressure to be generated in the mixing chamber 24, and the rotary action causes centrifugal acceleration of the material in an outward direction indicated by arrows 58 toward apertures 56 formed in the mixing chamber 24 walls. The rotating apertures shear the material as it evacuates the chamber 24.

The two feeding elements, 22A and 22B respectively, can each have a different number of openings 46. If the mixer is operated in a vertical orientation and the material being mixed has a component which tends to float on top, installing an upper feeding element 22A with more openings 46 and a lower feeding element 22B with fewer openings 46 will cause more material to be drawn from above than from below so as to facilitate incorporation of the floating material into the product. Conversely, if the mixture has a component which tends to sink, installing an upper feeding element 22A with fewer openings 46 and a lower feeding element 22B with more openings 46 will cause more material to be drawn from below than from above so as to facilitate incorporation of the heavy material into the product.

Under certain circumstances, for example when large amounts of powder are drawn into a somewhat viscous fluid, air can tend to accumulate in the center region 54 (see FIG. 1A) of the mixing head 20. This can diminish the flow rate of the process material through the mixing head. The addition of wings 26A on lateral portions of the central sleeve 26 (see FIG. lB) can reduce the tendency for air to accumulate, and therefore lead to improved maintenance of the circulation rate. In practice, it has been found that two such wings 26A are adequate, though additional wings can be used. Curved wings 26A are equally applicable; however, curved wings are more difficult to manufacture than straight wings. The addition of wings 26A increases the need for more positive drive to the sleeve 26; hence a hole 80 for a small pin (not shown) is added to the shoulder portion 32 of the bolt 28. The pin engages a keyway 82 in the sleeve 26 to provide the additional drive. Although a winged sleeve 26A is described and illustrated with reference to the embodiment of FIG. 1, such a sleeve is equally applicable to, and under the certain circumstances explained above, would improve the performance of, the embodiments described below, as well as other embodiments of the present invention.

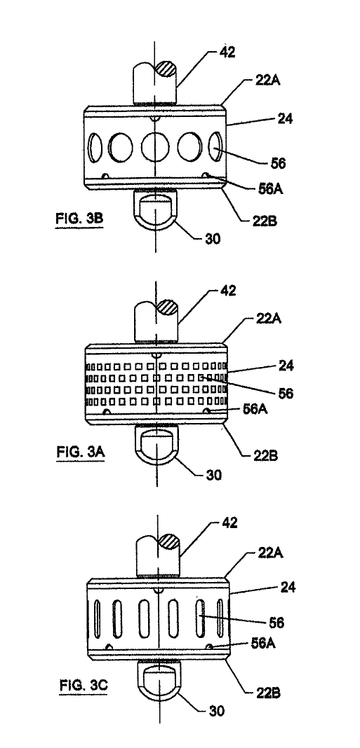

The mixing chamber 24 preferably comprises a cylindrical screen which can be made in a variety of lengths and have apertures 56 of a variety of different shapes and sizes. FIGS. 3A, 3B, and 3C show different embodiments of mixing chamber screen 24. The embodiment of FIG. 3A has a relatively large number of openings of relatively small size and imparts a high level of shear to the product making it suitable for processing materials which are difficult to mix. The embodiment of FIG. 3B has apertures which are round holes of relatively large diameter, presenting less resistance to flow through the mixing screen, making it especially suitable for rapid blending of simple mixtures and for the mixing of thick or viscous products. The embodiment of FIG. 3C has a series of longitudinal slots, providing more chopping action in the case of fibrous products. The leading edge of these slots can easily be sharpened, if required, to provide additional cutting action. It will be understood that apertures of other shapes and sizes can also be employed to satisfy specific mixing requirements. In this manner, a relatively inexpensive assortment of screens can be provided with the first and second feeding elements 22 to provide a modular system that is relatively easy to disassemble and service.

In cases where the mixing screens 24 have a solid, unperforated top and/or bottom edge, one or more notched openings 56A, for example three to six notched openings, may be provided along the top and/or bottom edges of the screens 24. The notches 56A allow for flow in the edge regions during operation, thereby preventing stagnation of product in the corners proximal to the edges. Further, such notches allow for the passage of cleaning materials, contributing to ease and efficiency of cleaning the mixing heads, and preventing residual product from being retained.

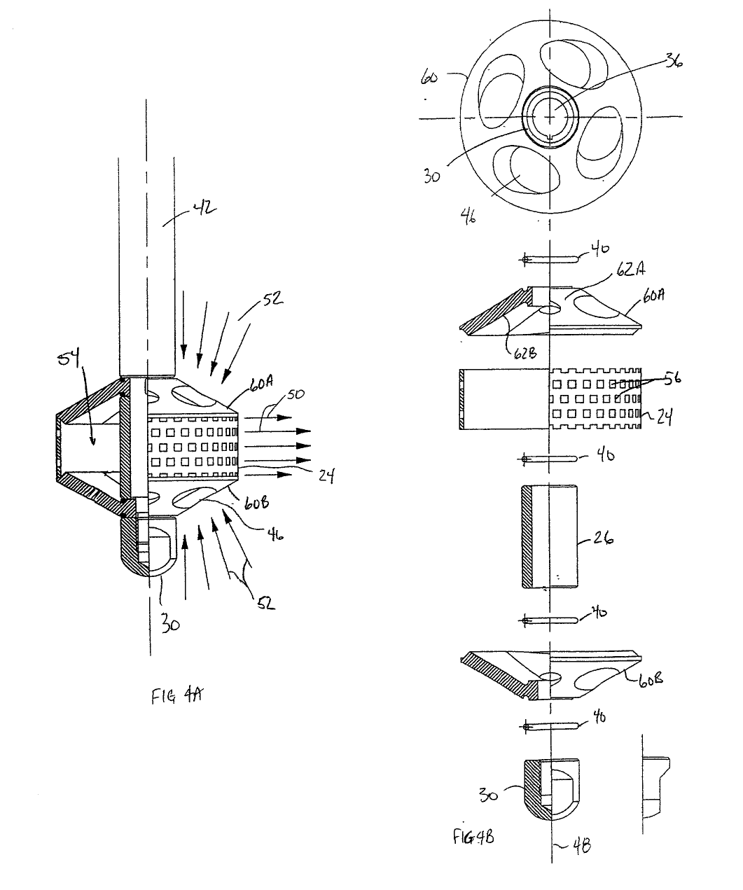

FIGS. 4A and 4B are a partial-sectional side view and an exploded perspective view respectively of a rotary mixer head in accordance with a first alternative embodiment of the present invention. In this embodiment, the upper and lower feeding elements 60A, 60B are formed to have inner and outer conical surfaces, 62A, 62B respectively. Openings 46 are provided between the inner and outer surfaces 62A, 62B, similar to the openings 46 described above with reference to FIGS. 1 and 2. The openings are provided at acute angles relative to the longitudinal axis 48 of the mixing head so as to induce primarily axial flow of material into the mixing chamber 54, as described above.

FIGS. 5A and 5B are a partial-sectional side view and an exploded perspective view respectively of a rotary mixer head in accordance with a second alternative embodiment of the present invention. In this embodiment, the upper and lower feeding elements 66A, 66B are formed to have inner and outer conical surfaces, 68A, 68B respectively, as in the embodiment of FIGS. 4A and 4B. However, in this embodiment, the openings 70 between the inner and outer surfaces 72A, 72B, are shaped consistent with sections of the cone. In addition, a leading edge 74 is beveled inwardly to direct material in an axial direction toward the mixing chamber during operation.

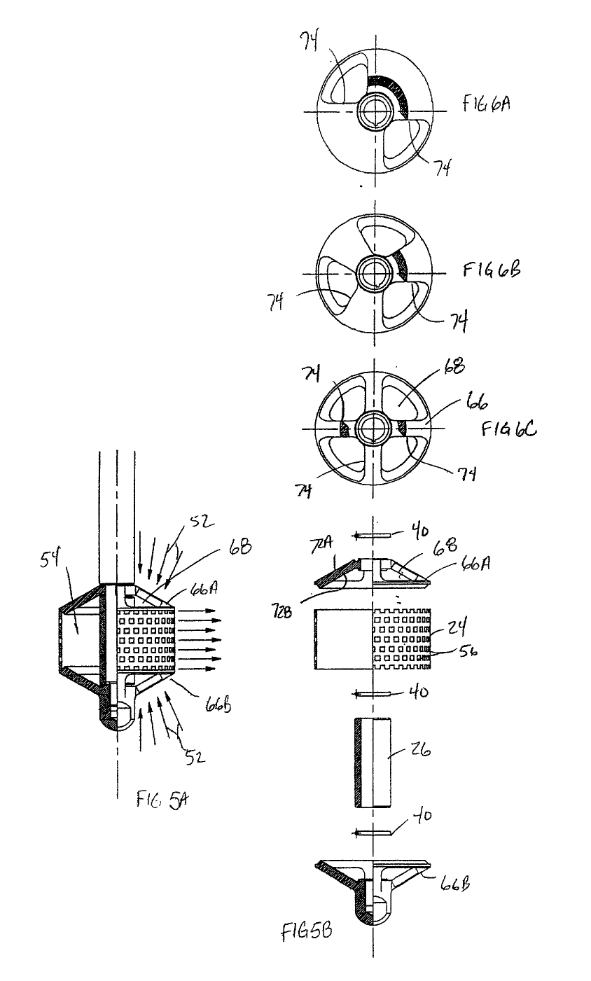

FIGS. 6A, 6B, and 6C are top views of various feeding elements of the FIG. 5 embodiment, including different numbers of openings, in accordance with the present invention. As described above, the number and sizes of the openings can be varied, depending on the material to be mixed, and desired flow considerations.

The amount of flow through the mixer head is controlled by several factors, the primary ones being rotational speed, the number and size of openings in the feeding elements, the orientation of the openings in the feeding elements, and the restriction to flow imposed by the mixing screen. Larger openings in the mixer screen reduce the restriction to flow, as does a greater amount of total open area. The modularity of the present invention permits a wide degree of flexibility in matching the rotary mixer head to the requirements of a specific mixing task.

Because the parts are machined all over (i.e., not cast or welded up in such a way as to preclude subsequent machining of all welds), they can all be readily provided with a smooth, sanitary surface finish without the need for manual grinding or polishing. Such a surface finish is important not only for sanitary applications, but also in preventing carry-over of other products such as pigments or chemicals from one batch to the next. The feeding elements can also be machined with a slight narrowing taper on both top and bottom surfaces, as the diameter increases, so as to promote drainage. Note that the definition of sanitary varies from industry to industry and may sometimes require a secondary electro-polishing operation.

While this invention has been particularly shown and described with references to preferred embodiments thereof, it will be understood by those skilled in the art that various changes in form and details may be made herein without departing from the spirit and scope of the invention as defined by the appended claims.

I claim:

1. A mixing head for mixing material comprising:
first and second spaced-apart feeding elements having opposed inner faces;
a cylindrical mixing screen disposed about a longitudinal axis of the mixing head between the inner faces of the mixing elements; the region between the first and second feeding elements and within the mixing screen defining a mixing chamber; and
the first and second feeding elements including a plurality of openings formed at acute angles relative to the longitudinal axis such that when rotated, the first and second feeding elements induce material flow in an axial direction through the openings and into the mixing chamber.

2. The mixing head of claim 1 wherein the openings have a substantially circular cross section.

3. The mixing head of claim 1 wherein the openings have respective center axes that lie on a circle centered at the longitudinal axis.

4. The mixing head of claim 1 wherein the feeding elements are substantially flat.

5. The mixing head of claim 1 wherein the feeding elements are substantially conical.

6. The mixing head of claim 5 wherein the openings are formed in the conical surface along sections of the cone.

7. The mixing head of claim 6 wherein a leading edge of the conical section opening is beveled inwardly toward an interior of the cone so as to induce axial flow of material.

8. The mixing head of claim 1 further comprising a sleeve between the first and second feeding elements, the sleeve being slightly shorter in length than the space between the feeding elements.

9. The mixing head of claim 8 further comprising first and second resilient O-rings at the interface of the sleeve and the first and second feeding elements.

10. The mixing head of claim 8 further comprising a bolt having a head and a thread, and wherein the first and second feeding elements include central bolt openings and wherein the thread portion of the bolt passes through the central bolt openings and through the sleeve, and wherein the head is larger in diameter than the bolt openings, for mounting the mixing head to a rotary shaft.

11. The mixing head of claim 10 further comprising third and fourth resilient O-rings at the interface of the bolt and the first feeding element, and the second feeding element and the shaft.

12. The mixing head of claim 8 wherein the sleeve includes at least one lateral wing extending from a central body of the sleeve.

13. The mixing head of claim 12 wherein the at least one lateral wing is linear in profile.

14. The mixing head of claim 1 wherein the cylindrical mixing screen includes a plurality of mixing apertures spaced at intervals along a body portion and top and bottom edges, the top and bottom edges including notches spaced at intervals for promoting material flow in the regions of the top and bottom edges.

15. A modular system for providing a mixing head for mixing material comprising:
a plurality of first and second feeding elements adapted to have opposed inner faces;
a plurality of cylindrical mixing screens adapted to be disposed about a longitudinal axis of the mixing head between the inner faces of the mixing elements; the region between the first and second feeding elements and within the mixing screen defining a mixing chamber; and
the first and second feeding elements including a plurality of openings such that when rotated, the first and second feeding elements induce material flow in an axial direction through the openings and into the mixing chamber; wherein any of the first and second feeding elements can be combined with one of the mixing screens to provide a desired mixing head configuration.

16. The modular system of claim 15 wherein the feeding element openings are formed at acute angles relative to the longitudinal axis.

17. The modular system of claim 16 wherein the angles are different for each respective feeding element.

18. The modular system of claim 15 wherein the respective feeding elements have different numbers of openings.

19. The modular system of claim 15 wherein the respective feeding elements have openings of different shapes.

20. The modular system of claim 15 wherein the respective mixing screens each include mixing apertures of different shapes.

21. The modular system of claim 15 wherein the respective mixing screens each include mixing apertures of different sizes.

22. The modular system of claim 15 wherein the respective mixing screens are of different longitudinal lengths.

23. The modular system of claim 15 wherein at least one of the plurality of cylindrical mixing screens includes a plurality of mixing apertures spaced at intervals along a body portion and top and bottom edges, the top and bottom edges including notches spaced at intervals for promoting material flow in the regions of the top and bottom edges.
